(19) United States
(12) Patent Application Publication
(10) Pub. No.: US 2011/0134200 A1
(43) Pub. Date: Jun. 9, 2011

(54) APPARATUS FOR TRANSPORTING TRANSPORTATION TARGET MEDIUM AND IMAGE FORMATION APPARATUS

(75) Inventor: Akihiko IKEGAMI, Okaya-shi (JP)

(73) Assignee: SEIKO EPSON CORPORATION, Tokyo (JP)

(21) Appl. No.: 12/943,392

(22) Filed: Nov. 10, 2010

(30) Foreign Application Priority Data
Dec. 9, 2009 (JP) 2009-279811

(51) Int. Cl. B41J 2/01; B65H 5/08; B65H 3/64

(52) U.S. Cl. 347/104; 271/12; 271/112

(57) ABSTRACT

An apparatus for transporting a transportation target medium, including: an endless belt that has a plurality of belt-side suction holes; and a supporting section that has a plurality of supporting-section-side suction holes, wherein a force of suction acts at areas where the belt-side suction holes substantially overlap the supporting-section-side suction holes for transporting the transportation target medium, the belt-side suction holes are arranged at a first pitch in a first direction, the supporting-section-side suction holes are arranged at the first pitch in a second direction, either of the belt-side suction holes and the supporting-section-side suction holes, or both the belt-side suction holes and the supporting-section-side suction holes, are quadrangular holes, and the open width of each of the quadrangular holes is one half of the first pitch.

### BACKGROUND

1. Technical Field

The present invention relates to an apparatus for transporting a transportation target medium and an image formation apparatus. In particular, the invention relates to an apparatus for transporting a sheet-type transportation target medium while applying a force of suction to it. In addition, the invention relates to an image formation apparatus to which such a transportation-target-medium transportation apparatus is applied.

2. Related Art

An apparatus disclosed in JP-A-2009-137141 is known as an example of an image formation apparatus to which the above type of a transportation-target-medium transportation apparatus is applied. The transportation-target-medium transportation apparatus is provided with, at least, a rotatable drum and an endless belt that is partially wound around the drum. The entire area of the outer circumferential surface of the drum is dotted with a plurality of drum-side suction holes. These holes are formed through the outer circumferential surface portion of the drum. The entire area of the belt is dotted with a plurality of belt-side suction holes formed therethrough.

Even when the belt is displaced relative to the drum to some degree at the part where the belt is wound around the drum, the belt-side suction holes overlap, that is, are located partially over, the drum-side suction holes to remain in communication. Therefore, it is still possible to suck a transportation target medium on the belt through these suction holes. However, because of the displacement of the belt relative to the drum, the area of each opening where the belt-side suction hole overlaps the drum-side suction hole (i.e., opening ratio) changes. Therefore, it is not possible to ensure that a constant force of suction (vacuuming force) is applied to the transportation target medium on the belt.

### SUMMARY

An advantage of some aspects of the invention is to provide an apparatus for transporting a transportation target medium that makes it possible to suck a recording target medium on a belt with a constant force of suction even when the belt is displaced. In addition, as an advantage of some aspects thereof, the invention provides an image formation apparatus to which such a transportation-target-medium transportation apparatus is applied.

To overcome the above disadvantage without any limitation thereto, the following features of some aspects of the invention are disclosed in this specification. An apparatus for transporting a transportation target medium according to a first aspect of the invention includes an endless belt and a supporting section. The endless belt has a plurality of belt-side suction holes that is formed therethrough. The supporting section has a plurality of supporting-section-side suction holes that is in communication with a depressurizing source. The supporting section supports a part of the endless belt that is driven to run. The supporting section guides the endless belt. A force of suction acts at areas where the belt-side suction holes substantially overlap the supporting-section-side suction holes for transporting the transportation target medium on the front surface of the endless belt in a predetermined direction while sucking the target medium. The belt-side suction holes are arranged at a first pitch in a first direction, which is either a direction of the length of the endless belt or a direction that is orthogonal to the direction of the length of the endless belt, to form each of a plurality of lines. The plurality of lines of the belt-side suction holes is formed adjacent to one another at a second pitch in a direction that is orthogonal to the first direction. One line of the belt-side suction holes and another line of the belt-side suction holes that is formed adjacent to the one line of the belt-side suction holes are staggered by one half of the first pitch. The supporting-section-side suction holes are arranged at the first pitch in a second direction, which is orthogonal to the first direction, to form each of a plurality of lines. The plurality of lines of the supporting-section-side suction holes is formed adjacent to one another at the second pitch in a direction that is orthogonal to the second direction. One line of the supporting-section-side suction holes and another line of the supporting-section-side suction holes that is formed adjacent to the one line of the supporting-section-side suction holes are staggered by one half of the first pitch. Either of the belt-side suction holes and the supporting-section-side suction holes, or both the belt-side suction holes and the supporting-section-side suction holes, are quadrangular holes. The open width of each of the quadrangular holes is one half of the first pitch. With such a structure, even when the relative position of the endless belt shifts on the supporting section, the total of the open areas of the overlapping parts is always constant. Therefore, it is possible to apply a constant sucking force to the transportation target medium on the endless belt.

In the structure of an apparatus for transporting a transportation target medium according to the first aspect of the invention, preferably, the belt-side suction holes should be round holes, whereas the supporting-section-side suction holes should be the quadrangular holes. With such a preferred structure, the shape of the belt-side suction holes and the shape of the supporting-section-side suction holes are optimized for the material of the endless belt and the material of the supporting section, respectively. In the structure of an apparatus for transporting a transportation target medium according to the first aspect of the invention, preferably, the supporting section should include a rotatable drum that causes the endless belt to run. With such a preferred structure, when the supporting section includes the rotatable drum, it is possible to produce the same advantageous effect as above.

An image formation apparatus according to a second aspect of the invention includes a liquid ejecting head, an endless belt, and a supporting section. The liquid ejecting head ejects liquid. The endless belt has a plurality of belt-side suction holes that is formed therethrough. The endless belt runs in a direction of transportation through a position opposite to the liquid ejecting head. The supporting section has a plurality of supporting-section-side suction holes that is in communication with a depressurizing source. The supporting section supports a part of the endless belt that is driven to run. The supporting section guides the endless belt. A force of suction acts at areas where the belt-side suction holes substantially overlap the supporting-section-side suction holes for transporting a transportation target medium on the front surface of the endless belt in a predetermined direction while sucking the target medium. The belt-side suction holes are arranged at a first pitch in a first direction, which is either a direction of the length of the endless belt or a direction that is orthogonal to the direction of the length of the endless belt, to form each of a plurality of lines. The plurality of lines of the belt-side suction holes is formed adjacent to one another at a second pitch in a direction that is orthogonal to the first direction. One line of the belt-side suction holes and another line of the belt-side suction holes that is formed adjacent to the one line of the belt-side suction holes are staggered by one half of the first pitch. The supporting-section-side suction holes are arranged at the first pitch in a second direction, which is orthogonal to the first direction, to form each of a plurality of lines. The plurality of lines of the supporting-section-side suction holes is formed adjacent to one another at the second pitch in a direction that is orthogonal to the second direction. One line of the supporting-section-side suction holes and another line of the supporting-section-side suction holes that is formed adjacent to the one line of the supporting-section-side suction holes are staggered by one half of the first pitch. Either of the belt-side suction holes and the supporting-section-side suction holes, or both the belt-side suction holes and the supporting-section-side suction holes, are quadrangular holes. The open width of each of the quadrangular holes is one half of the first pitch. With such a structure, even when the relative position of the endless belt shifts on the supporting section, the total of the open areas of the overlapping parts is always constant. Therefore, it is possible to apply a constant sucking force to the transportation target medium on the endless belt during the formation of an image.

In the structure of an image formation apparatus according to the second aspect of the invention, preferably, the belt-side suction holes should be round holes, whereas the supporting-section-side suction holes should be the quadrangular holes. With such a preferred structure, the shape of the belt-side suction holes and the shape of the supporting-section-side suction holes are optimized for the material of the endless belt and the material of the supporting section, respectively. In the structure of an image formation apparatus according to the second aspect of the invention, preferably, the supporting section should include a rotatable drum that causes the endless belt to run. With such a preferred structure, when the supporting section includes the rotatable drum, it is possible to produce the same advantageous effect as above.

### BRIEF DESCRIPTION OF THE DRAWINGS

The invention will be described with reference to the accompanying drawings, wherein like numbers reference like elements.

FIG. 1 is a side sectional view that schematically illustrates an example of the structure of an image formation apparatus according to an exemplary embodiment of the invention.

FIG. 2 is a diagram that schematically illustrates an example of the structure of the outer circumferential surface of a drum according to an exemplary embodiment of the invention.

FIG. 3 is a diagram that schematically illustrates an example of the structure of the surface of a belt according to an exemplary embodiment of the invention.

FIG. 4 is a diagram that schematically illustrates a state in which the belt is not displaced at all relative to the drum according to an exemplary embodiment of the invention.

FIG. 5 is a diagram that schematically illustrates a state in which the belt is displaced relative to the drum in the direction of the length of the belt.

FIG. 6 is a diagram that schematically illustrates a state in which the belt is displaced relative to the drum in the direction of the width of the belt.

### DESCRIPTION OF EXEMPLARY EMBODIMENTS

With reference to the accompanying drawings, exemplary embodiments of the present invention will now be explained in detail. In the drawings referred to in the following description, the same reference numerals are used for components having the same structure to avoid repeated explanation.

### Structure of Image Formation Apparatus

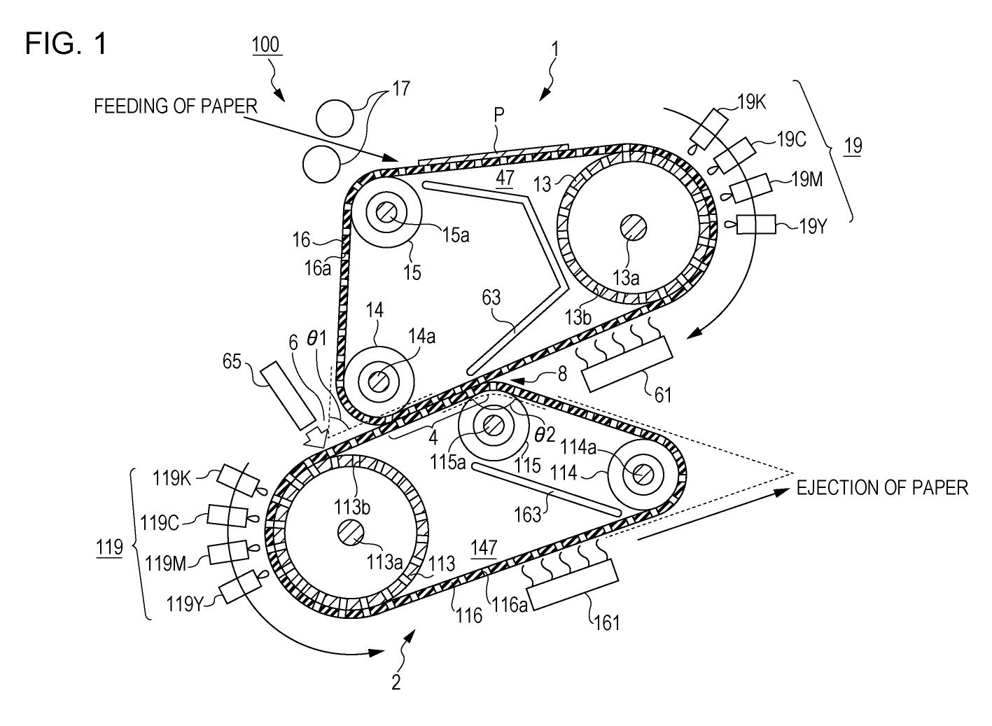

FIG. 1 is a side sectional view that schematically illustrates an example of the structure of a duplex image formation apparatus according to an exemplary embodiment of the invention.

A duplex image formation apparatus 100 includes a front-side image formation apparatus 1 and a reverse-side image formation apparatus 2. As illustrate in FIG. 1, the front-side image formation apparatus 1 and the reverse-side image formation apparatus 2 are disposed along a transportation path of recording paper P. For example, the front-side image formation apparatus 1 is an ink-jet printer. The front-side image formation apparatus 1 performs printing in a line-recording scheme. The reverse-side image formation apparatus 2 is also a line ink-jet printer. As illustrated in FIG. 1, the front-side image formation apparatus 1 includes a driving drum (hereinafter simply referred to as drum) 13, driven rollers (hereinafter simply referred to as roller) 14 and 15, an endless loop belt (hereinafter simply referred to as belt) 16, and a partition wall member 63. As a means for transporting the recording paper P, which is an example of a transportation target medium, the drum 13, the rollers 14 and 15, and the belt 16 constitute an example of an apparatus for transporting the transportation target medium. The belt 16 is stretched between the drum 13 and the rollers 14 and 15 in such a manner that it is partially wound around each of the drum 13, the roller 14, and the roller 15.

The drum 13 and the rollers 14 and 15 have respective rotating shafts 13a, 14a, and 15a. The rotating shafts 13a, 14a, and 15a extend through the cross-sectional centers of the drum 13 and the rollers 14 and 15, respectively. Bearings support each of the rotating shafts 13a, 14a, and 15a rotatably. The bearings are not illustrated in the drawing. The drum 13, the roller 14, and the roller 15 function as an example of a supporting section according to an aspect of the invention. The supporting section supports a part of the belt 16 and guides the belt 16 downstream in the direction of transportation. The three rotating shafts 13a, 14a, and 15a rotate in the same direction, for example, clockwise. As these rotating shafts 13a, 14a, and 15a rotate, the belt 16 runs in one direction while being stretched between the drum 13 and the rollers 14 and 15.

For example, the output shaft of a driving source such as an electric motor or the like is connected to the rotating shaft 13a of the drum 13 either directly or through a speed reduction mechanism. The power of the electric motor is transmitted to the rotating shaft 13a. When the electric motor, which is the driving source, rotates in its normal direction, the drum 13 is driven to rotate around the rotating shaft 13a. As will be explained later, a plurality of suction holes 13b is formed in the outer circumferential surface of the drum 13. An example of the material of the belt 16 is rubber. As will be explained later, a plurality of suction holes 16a is formed in the surface of the belt 16. A negative pressure suction method is used to hold the recording paper P on the surface of the belt 16. That is, negative pressure is applied to the suction holes 16a of the belt 16 through the suction holes 13b of the drum 13 so as to suck (e.g., vacuum chuck) the recording paper P therethrough. For example, a depressurizing source, which is not illustrated in the drawing, reduces inner pressure to suck air toward the inner space of the drum 13. That is, the force of suction generated by the depressurizing source acts through the suction holes 13b and the suction holes 16a.

The partition wall member 63 is provided in a space 47 inside the belt 16 and outside the drum 13. The function of the partition wall member 63 is to demarcate a region to which negative pressure is applied in the space 47. Since the partition wall member 63 is provided in the space 47, the region surrounded by the partition wall member 63, the reverse face of the belt 16, and the outer circumferential surface of the drum 13 is substantially hermetically closed. Therefore, negative pressure is kept thereat. For this reason, at the surface of the belt 16, a force of suction due to the application of negative pressure thereto acts not only at the part of the belt 16 that is curved along the drum 13 but also at the part of the belt 16 that is not curved along the drum 13 near the curved part. That is, the force of suction acts also at the part of the belt 16 immediately upstream of the curved part and the part of the belt 16 immediately downstream of the curved part.

As a means for feeding the recording paper P onto the belt 16, for example, the front-side image formation apparatus 1 is provided with a pair of gate rollers 17. The gate rollers 17 mechanically correct the skew of the recording paper P by bringing their roller surfaces into contact with the recording paper P. In addition, the gate rollers 17 are configured to feed the recording paper P to a target position on the belt 16 in synchronization with drive-start timing.

As a means for performing recording operation on the recording paper P, for example, the front-side image formation apparatus 1 is provided with a line-recording type head (hereinafter referred to as line head) 19. The line head 19 is provided at a position opposite to a part of the outer circumferential surface of the drum 13 with a part of the belt 16 therebetween. The line head 19, which is an example of a liquid ejecting head according to an aspect of the invention, is made up of, for example, four line heads 19Y, 19M, 19C, and 19K. The line heads 19Y, 19M, 19C, and 19K discharge ink droplets of four colors, which are yellow (Y), magenta (M), cyan (C), and black (K), respectively. Ink of the corresponding color is supplied from an ink tank (not shown) in which it is contained to each of the line heads 19Y, 19M, 19C, and 19K through an ink supply tube. That is, the ink of the above four colors is supplied from the ink tanks through the tubes separately. The line heads 19Y, 19M, 19C, and 19K are arranged at predetermined spaces in the circumferential direction along the outer circumferential surface of the drum 13.

Each of the line heads 19Y, 19M, 19C, and 19K has a plurality of nozzles aligned in the direction that is orthogonal to the direction of transportation of the recording paper P in a plan view (i.e., in the direction of the width of the recording paper P). The line of the nozzles is long enough so that it is possible to perform recording throughout the entire width of a sheet of paper having the maximum size available for printing. Each of the line heads 19Y, 19M, 19C, and 19K ejects a required amount of ink in the form of droplets from the nozzles to positions on the recording paper P where it is necessary to form dots. By this means, the line head 19 forms very small ink dots on the recording paper P. The formation of ink dots is carried out for each of the above four colors. In this way, the front-side image formation apparatus 1 can perform printing on the front of the recording paper P held on the belt 16.

As a means for drying the discharged ink droplets on the recording paper P, for example, the front-side image formation apparatus 1 is provided with a drying device 61 such as a halogen lamp, a warm air blower, or the like. As illustrated in FIG. 1, the drying device 61 is provided at a position downstream of the line head 19 in the direction of transportation of the recording paper P. In addition, as illustrated therein, the drying device 61 faces a part of the surface of the belt 16 at the downstream position. As illustrated in FIG. 1, the basic structure of the reverse-side image formation apparatus 2 is the same as that of the front-side image formation apparatus 1. Specifically, as a means for transporting the recording paper P, for example, the reverse-side image formation apparatus 2 includes a drum 113, rollers 114 and 115, and a belt 116. The belt 116 is stretched between the drum 113 and the rollers 114 and 115 in such a manner that it is partially wound around each of the drum 113, the roller 114, and the roller 115. In addition, the reverse-side image formation apparatus 2 includes a partition wall member 163.

As a means for performing recording operation on the recording paper P, for example, the reverse-side image formation apparatus 2 is provided with line heads 119Y, 119M, 119C, and 119K, which are collectively denoted as line head 119. The line head 119 is provided at a position opposite to a part of the outer circumferential surface of the drum 113 with a part of the belt 116 therebetween. Besides the above components, the reverse-side image formation apparatus 2 is provided with a drying device 161 such as a halogen lamp, a warm air blower, or the like as a means for drying ink droplets on the recording paper P. The structure and function of each of the transporting means, the recording means, the drying means, and a detecting means of the reverse-side image formation apparatus 2 is the same as that of the counterpart of the front-side image formation apparatus 1.

The duplex image formation apparatus 100 includes a relaying portion 4 that passes a sheet of the recording paper P from the front-side image formation apparatus 1 to the reverse-side image formation apparatus 2. The sheet is turned over before it is passed to the reverse-side image formation apparatus 2. The surface of the belt 16 of the front-side image formation apparatus 1 and the surface of the belt 116 of the reverse-side image formation apparatus 2 are in contact with each other at a prescribed overlapping region in the direction of transportation of the recording paper P. The relaying portion 4 is formed as the surface contact portion of the belts 16 and 116. The roller 14 of the front-side image formation apparatus 1 serves as a portion for releasing the outgoing recording paper P. The portion is hereinafter referred to as releasing portion 6. The roller 115 of the reverse-side image formation apparatus 2 serves as a portion for receiving the incoming recording paper P. The portion is hereinafter referred to as receiving portion 8. The angle of the part of the belt 16 that is curved along the roller 14 functioning as the releasing portion 6, which is denoted as θ1, is an acute angle. The angle of the part of the belt 116 that is curved along the roller 115 functioning as the receiving portion 8, which is denoted as θ2, is an obtuse angle.

The line head 19 performs printing on the front of a sheet of the recording paper P. After the printing, the recording paper P is transported on the belt 16 to the position of the roller 14, which is a downstream position in the transportation direction. The recording paper P is self-stripped (“curvature released”) at the curved surface of the belt 16 of which curvature is changed substantially depending on the diameter of the roller 14. The recording paper P is passed from the front-side image formation apparatus 1 to the reverse-side image formation apparatus 2. After having been passed to the reverse-side image formation apparatus 2, the recording paper P is transported downstream on the belt 116. The line head 119 performs printing on the back of the sheet of the recording paper P. After the printing, the recording paper P is transported on the belt 116 to the position of the roller 114, which is a downstream position in the transportation direction. The recording paper P is self-stripped at the curved surface of the belt 116 of which curvature is changed substantially depending on the diameter of the roller 114. The released recording paper P is ejected to the outside.

In the setting of the duplex image formation apparatus 100, the transportation velocity of the belt 116 of the reverse-side image formation apparatus 2, which is denoted as V2, is slightly higher than that of the belt 16 of the front-side image formation apparatus 1, which is denoted as V1. A paper edge detector 65 is provided immediately downstream of the relaying portion 4 in the transportation direction. The paper edge detector 65 detects the leading edge of the recording paper P on the front of which an image or the like has been printed. The paper edge detector 65 sends the detected edge to the storage area of the reverse-side image formation apparatus 2. By this means, it is possible to perform printing on the back of the sheet of the recording paper P while ensuring high precision in the reverse-side recording position.

### Structure of Drum and Belt

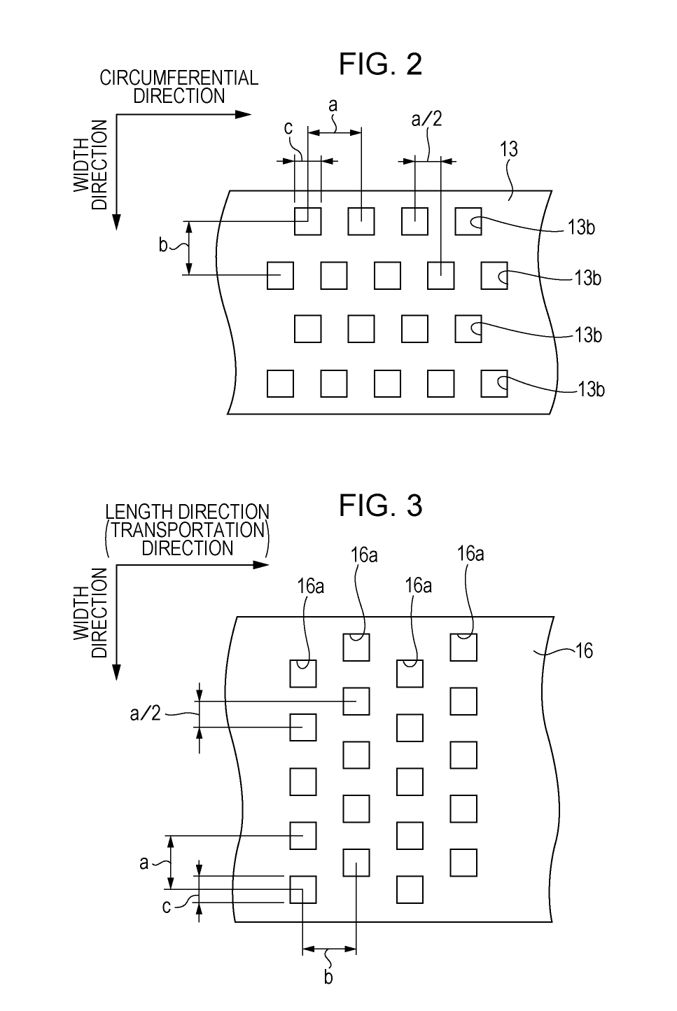

Next, with reference to FIGS. 2 and 3, the features of the suction holes 13b of the drum 13 and the suction holes 16a of the belt 16, including but not limited to the arrangement and shape of these suction holes, will now be explained in detail. The plurality of suction holes 13b is formed throughout the entire area of the outer circumferential surface of the drum 13 in a pattern illustrated in FIG. 2. The suction holes 13b are formed for holding the recording paper P on the surface of the belt 16 through the suction holes 16a of the belt 16 by utilizing a force of suction. As illustrated in FIG. 2, a plurality of suction holes 13b is arranged at equal intervals in the circumferential direction of the drum 13 to form each of a plurality of lines. The interval is hereinafter referred to as pitch “a”. The number of lines is denoted as M. The number of lines is four in the illustrated example. The M lines of the suction holes 13b are formed adjacent to and parallel with one another at equal intervals in the direction of the width of the drum 13. The interval is hereinafter referred to as pitch b. One line of the suction holes 13b and another line of the suction holes 13b that is formed adjacent to the one line of the suction holes 13b are shifted in staggered arrangement in the circumferential direction of the drum 13 by a shift distance equal to ½ of the pitch a (i.e., a half circumferential pitch). The pitch a may be the same as the pitch b. The pitch a may be different from the pitch b.

The suction hole 13b is a hole that is formed through the outer circumferential surface portion of the drum 13. The suction hole 13b is a quadrangular hole. Therefore, as illustrated in FIG. 2, the suction hole 13b has a quadrangular opening at each of both open ends. In the illustrated example, the suction hole 13b has a square opening at each of both open ends. The open width of the suction hole 13b, which is denoted as c, is one half of the pitch a (a/2). On the other hand, the plurality of suction holes 16a is formed throughout the entire area of the belt 16 in a pattern illustrated in FIG. 3. The suction holes 16a are formed for holding the recording paper P on the surface of the belt 16 by utilizing a force of suction.

As illustrated in FIG. 3, a plurality of suction holes 16a is arranged at equal intervals, that is, the pitch a, in the direction of the width of the belt 16 to form each of a plurality of lines. The number of lines is denoted as N. The number of lines is four in the illustrated example. The N lines of the suction holes 16a are formed adjacent to and parallel with one another at equal intervals, that is, the pitch b, in the direction of the length of the belt 16 (i.e., in the direction of transportation of the recording paper P). One line of the suction holes 16a and another line of the suction holes 16a that is formed adjacent to the one line of the suction holes 16a are shifted in staggered arrangement in the direction of the width of the belt 16 by a shift distance equal to one half of the pitch a (a/2). The suction hole 16a is a hole that is formed through the belt 16 from its front surface to its reverse surface. The suction hole 16a is a quadrangular hole. Therefore, as illustrated in FIG. 3, the suction hole 16a has a quadrangular opening at each of both open ends. In the illustrated example, the suction hole 16a has a square opening at each of both open ends. The open width of the suction hole 16a, which is denoted as c, is one half of the pitch a (a/2).

### Advantageous Effect Produced by Drum and Belt

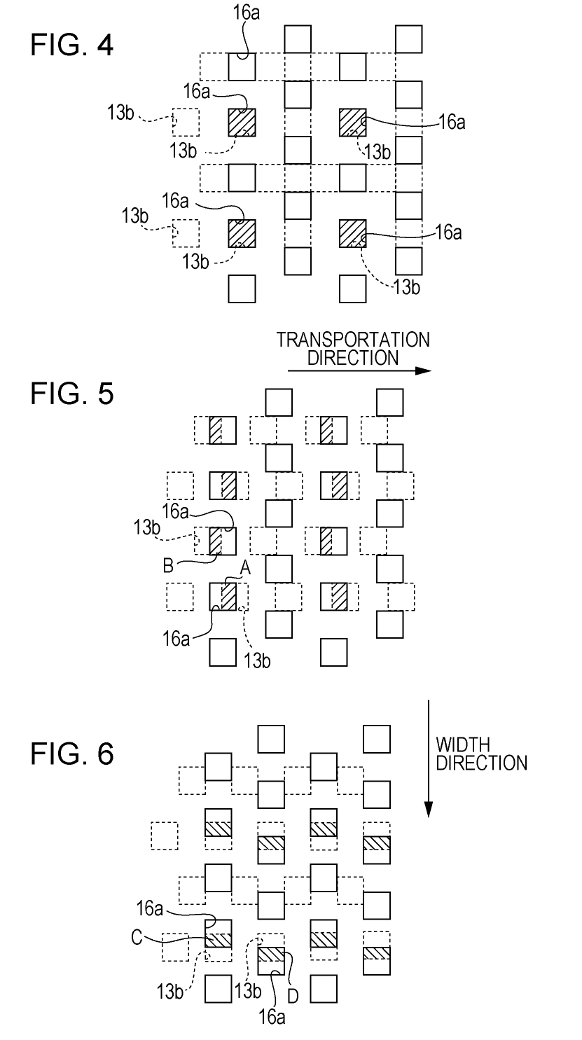

Next, with reference to FIGS. 4, 5, and 6, an advantageous effect produced by the drum 13 and the belt 16 will now be explained. FIG. 4 illustrates a state in which the belt 16 and the drum 13 are at a predetermined reference position. When the belt 16 and the drum 13 are at the reference position, the belt 16 is not displaced at all relative to the drum 13. In such a perfectly aligned state, some of the suction holes 16a of the belt 16 are located at the areas of some of the suction holes 13b of the drum 13 without any displacement. In this state, these suction holes (i.e., some suction holes mentioned above) 16a and 13b are in communication with each other. In other words, these suction holes 16a and 13b constitute through holes without any shift in position. In the illustrated example, suction holes located at four positions shown by hatched lines are in a communicated state. The total of the open areas of the suction holes in a communicated state is equal to the sum of the hatched areas in FIG. 4.

FIG. 5 illustrates a state in which the belt 16 is displaced relative to the drum 13 in the direction of the length of the belt 16 (i.e., in the transportation direction) from the state shown in FIG. 4. Each of the four suction holes 16a located at the hatched positions in FIG. 4 over the corresponding one of the suction holes 13b without any displacement overlaps the corresponding one of the suction holes 13b due to displacement in FIG. 5. That is, the hatched suction holes 16a are located partially over the hatched suction holes 13b in FIG. 5. Therefore, in the state illustrated in FIG. 5, the suction holes remain in a communicated state at the overlapping areas only (e.g., hatched areas A in FIG. 5). For this reason, the area of each of these suction holes in a communicated state decreases.

For the purpose of explanation, attention is focused on another group of four suction holes 16a that are located adjacent to the four suction holes 16a explained above, specifically, four top-of-the-drawing-side adjacent suction holes 16a. Each of these four suction holes 16a overlaps the corresponding one of the suction holes 13b due to displacement in FIG. 5. Therefore, these suction holes become communicated with each other at the overlapping areas (e.g., hatched areas B in FIG. 5). The in-communication area of each of the second-mentioned suction holes is equal to the decrease in the area of each of the first-mentioned suction holes in a communicated state. For this reason, it follows that the former compensates for the decrease in the latter. Thus, even in a case where the belt 16 is displaced relative to the drum 13 in the direction of the length of the belt 16, the total of the open areas of the suction holes in a communicated state is equal to the sum of the hatched areas in FIG. 5, which is the same as the sum of the hatched areas in FIG. 4. Therefore, the ratio of opening does not change.

FIG. 6 illustrates a state in which the belt 16 is displaced relative to the drum 13 in the direction of the width of the belt 16 from the state shown in FIG. 4. Each of the four suction holes 16a located at the hatched positions in FIG. 4 over the corresponding one of the suction holes 13b without any displacement overlaps the corresponding one of the suction holes 13b due to displacement in FIG. 6. That is, the hatched suction holes 16a are located partially over the hatched suction holes 13b in FIG. 6. Therefore, in the state illustrated in FIG. 6, the suction holes remain in a communicated state at the overlapping areas only (e.g., hatched areas C in FIG. 6). For this reason, the area of each of these suction holes in a communicated state decreases.

For the purpose of explanation, attention is focused on another group of four suction holes 16a that are located adjacent to the four suction holes 16a explained above, specifically, four right adjacent suction holes 16a (though staggered). Each of these four suction holes 16a overlaps the corresponding one of the suction holes 13b due to displacement in FIG. 6. Therefore, these suction holes become communicated with each other at the overlapping areas (e.g., hatched areas D in FIG. 6). The in-communication area of each of the second-mentioned suction holes is equal to the decrease in the area of each of the first-mentioned suction holes in a communicated state. For this reason, it follows that the former compensates for the decrease in the latter. Thus, even in a case where the belt 16 is displaced relative to the drum 13 in the direction of the width of the belt 16, the total of the open areas of the suction holes in a communicated state is equal to the sum of the hatched areas in FIG. 6, which is the same as the sum of the hatched areas in FIG. 4. Therefore, the ratio of opening does not change.

An advantageous effect of the present embodiment of the invention is explained above under an assumption that the belt 16 is displaced relative to the drum 13 either in the direction of the length of the belt 16 or in the direction of the width of the belt 16. However, the above advantageous effect can be produced even in a case where the belt 16 is displaced relative to the drum 13 in an oblique direction. In the present embodiment of the invention, as explained while referring to FIG. 2, a plurality of suction holes 13b is arranged in the circumferential direction of the drum 13 to form each of a plurality of lines adjacent to and parallel with one another in the direction of the width of the drum 13. In addition, as explained while referring to FIG. 3, a plurality of suction holes 16a is arranged in the direction of the width of the belt 16 to form each of a plurality of lines adjacent to and parallel with one another in the direction of the length of the belt 16. However, the array directions of the suction holes 16a of the belt 16 and the suction holes 13b of the drum 13 are not limited to the above example. That is, any combination of directions orthogonal to each other may be adopted for the array directions of the suction holes 16a and the suction holes 13b. For example, a combination of a direction to the right with respect to the running direction of the belt 16 at an angle of 30° and a direction to the left with respect to the running direction of the belt 16 at an angle of 60° may be adopted for the array directions of the suction holes 16a and the suction holes 13b.

As will be understood from the above explanation, a means for transporting the recording paper P according to the present embodiment of the invention offers the following advantage. When the belt 16 is displaced relative to the drum 13, the overlapping pattern of the suction holes 16a of the belt 16 and the suction holes 13b of the drum 13 changes. However, despite such a change in the overlapping pattern, the total of the open areas of the overlapping parts, that is, the total of the open areas of the suction holes in a communicated state, remains the same as that of a state without any displacement. In other words, irrespective of whether the belt 16 is displaced relative to the drum 13 or not, it is possible to keep the same effective opening ratio of suction holes. Thus, irrespective of whether the belt 16 is displaced relative to the drum 13 or not, a means for transporting the recording paper P according to the present embodiment of the invention makes it possible to apply a constant force of suction to the recording paper P on the belt 16.

### Variation Examples of Structure of Drum and Belt

Next, variation examples of the structure of the drum 13 and the belt 16 will now be explained. In the illustrated example of FIG. 2, a plurality of suction holes 13b is arranged with the pitch a in the circumferential direction of the drum 13 to form each of a plurality of lines. As a variation example, the plurality of suction holes 13b may be arranged with the pitch a in the direction of the width of the drum 13, which is orthogonal to the circumferential direction thereof. In such a variation example, unlike the illustrated example of FIG. 3, a plurality of suction holes 16a is arranged with the pitch a in the direction of the length of the belt 16 (i.e., in the transportation direction) to form each of a plurality of lines.

In the illustrated example of FIG. 3, a plurality of suction holes 16a is arranged with the pitch a in the direction of the width of the belt 16 to form each of a plurality of lines. As a variation example, the plurality of suction holes 16a may be arranged with the pitch a in the direction of the length of the belt 16, which is orthogonal to the direction of the width thereof. In such a variation example, unlike the illustrated example of FIG. 2, a plurality of suction holes 13b is arranged with the pitch a in the direction of the width of the drum 13 to form each of a plurality of lines. As explained above, the array directions of the suction holes 16a of the belt 16 and the suction holes 13b of the drum 13 may be modified as long as they are orthogonal to each other.

In the illustrated example of FIG. 2, each of the suction holes 13b of the drum 13 is a square hole. The open width c of the suction hole 13b is one half of the pitch a. In the illustrated example of FIG. 3, each of the suction holes 16a of the belt 16 is also a square hole. The open width c of the suction hole 16a is also one half of the pitch a. However, the scope of the invention is not limited to such an exemplary structure. The structure of the suction holes 16a of the belt 16 or the suction holes 13b of the drum 13 may be modified as long as either of the suction holes 13b and the suction holes 16a, or both of them, are quadrangular holes, and in addition, the open width c of each of the quadrangular holes is one half of the pitch a. Therefore, if each of the suction holes 13b of the drum 13 is formed as a quadrangular hole, each of the suction holes 16a of the belt 16 may be formed as a round hole. The open width (i.e., diameter) of the round hole may be smaller than the open width c of the quadrangular hole. The open width of the round hole may be not smaller than the open width c of the quadrangular hole. The drum 13 and the belt 16 can produce the above advantageous effect even when modified as above.

For example, in some cases, in a structure that includes a combination of quadrangular suction holes and round suction holes, metal is used as the material of the drum 13, whereas rubber is used as the material of the belt 16. In such a case, from the viewpoint of material characteristics, machinability, and the like, it is preferable to form the suction holes 13b of the drum 13, which is made of metal, as quadrangular holes and the suction holes 16a of the belt 16, which is made of rubber, as round holes.

### Another Embodiment

(1) In the structure of an image formation apparatus illustrated in FIG. 1, a transportation unit that is provided with, at least, the drum 13, which rotates when driven by the source, and the belt 16, which is an endless belt that is partially wound around the drum 13, is used as a means for transporting the recording paper P. However, the scope of the invention is not limited to such an exemplary structure. For example, as a substitute for the foregoing exemplary transportation unit, a transportation unit (i.e., a transportation scheme) that includes an endless belt and a platen (supporting section) may be used. The endless belt is stretched between a driving roller and a driven roller, which rotates by following the rotation of the driving roller. The platen is in communication with a depressurizing source, supports a part of the belt 16, and guides the belt 16.

In such a structure, a plurality of suction holes that is the same as or similar to the suction holes 16a of the belt 16 illustrated in FIG. 1 is formed through the endless belt in a pattern illustrated in FIG. 3. On the other hand, a plurality of suction holes that is the same as or similar to the suction holes 13b of the drum 13 illustrated in FIG. 1 is formed through the platen in a pattern illustrated in FIG. 2. The line head 19 illustrated in FIG. 1, which is an example of a liquid ejecting head according to an aspect of the invention, is provided at a position opposite to the platen. A force of suction generated due to pressure reduction by the depressurizing source acts at areas where the belt-side suction holes substantially overlap the platen-side suction holes. The transportation unit transports a sheet of recording paper in a predetermined direction while sucking the recording paper, which is held on the surface of the endless belt.

The entire disclosure of Japanese Patent Application No. 2009-279811, filed Dec. 9, 2009 is expressly incorporated by reference herein.

What is claimed is:

1. An apparatus for transporting a transportation target medium, comprising:
an endless belt that has a plurality of belt-side suction holes that is formed through the endless belt; and
a supporting section that has a plurality of supporting-section-side suction holes that is in communication with a depressurizing source, the supporting section supporting a part of the endless belt that is driven to run, the supporting section guiding the endless belt,
wherein a force of suction acts at areas where the belt-side suction holes substantially overlap the supporting-section-side suction holes for transporting the transportation target medium on the front surface of the endless belt in a predetermined direction while sucking the target medium,
the belt-side suction holes are arranged at a first pitch in a first direction, which is either a direction of the length of the endless belt or a direction that is orthogonal to the direction of the length of the endless belt, to form each of a plurality of lines,
the plurality of lines of the belt-side suction holes is formed adjacent to one another at a second pitch in a direction that is orthogonal to the first direction,
one line of the belt-side suction holes and another line of the belt-side suction holes that is formed adjacent to the one line of the belt-side suction holes are staggered by one half of the first pitch,
the supporting-section-side suction holes are arranged at the first pitch in a second direction, which is orthogonal to the first direction, to form each of a plurality of lines,
the plurality of lines of the supporting-section-side suction holes is formed adjacent to one another at the second pitch in a direction that is orthogonal to the second direction,
one line of the supporting-section-side suction holes and another line of the supporting-section-side suction holes that is formed adjacent to the one line of the supporting-section-side suction holes are staggered by one half of the first pitch,
either of the belt-side suction holes and the supporting-section-side suction holes, or both the belt-side suction holes and the supporting-section-side suction holes, are quadrangular holes, and
the open width of each of the quadrangular holes is one half of the first pitch.

2. The apparatus for transporting a transportation target medium according to claim 1, wherein the belt-side suction holes are round holes, whereas the supporting-section-side suction holes are the quadrangular holes.

3. The apparatus for transporting a transportation target medium according to claim 1, wherein the supporting section includes a rotatable drum that causes the endless belt to run.

4. An image formation apparatus comprising:
a liquid ejecting head that ejects liquid;
an endless belt that has a plurality of belt-side suction holes that is formed through the endless belt, the endless belt running in a direction of transportation through a position opposite to the liquid ejecting head; and
a supporting section that has a plurality of supporting-section-side suction holes that is in communication with a depressurizing source, the supporting section supporting a part of the endless belt that is driven to run, the supporting section guiding the endless belt,
wherein a force of suction acts at areas where the belt-side suction holes substantially overlap the supporting-section-side suction holes for transporting a transportation target medium on the front surface of the endless belt in a predetermined direction while sucking the target medium,
the belt-side suction holes are arranged at a first pitch in a first direction, which is either a direction of the length of the endless belt or a direction that is orthogonal to the direction of the length of the endless belt, to form each of a plurality of lines,
the plurality of lines of the belt-side suction holes is formed adjacent to one another at a second pitch in a direction that is orthogonal to the first direction,
one line of the belt-side suction holes and another line of the belt-side suction holes that is formed adjacent to the one line of the belt-side suction holes are staggered by one half of the first pitch,
the supporting-section-side suction holes are arranged at the first pitch in a second direction, which is orthogonal to the first direction, to form each of a plurality of lines,
the plurality of lines of the supporting-section-side suction holes is formed adjacent to one another at the second pitch in a direction that is orthogonal to the second direction,
one line of the supporting-section-side suction holes and another line of the supporting-section-side suction holes that is formed adjacent to the one line of the supporting-section-side suction holes are staggered by one half of the first pitch,
either of the belt-side suction holes and the supporting-section-side suction holes, or both the belt-side suction holes and the supporting-section-side suction holes, are quadrangular holes, and
the open width of each of the quadrangular holes is one half of the first pitch.

5. The image formation apparatus according to claim 4, wherein the belt-side suction holes are round holes, whereas the supporting-section-side suction holes are the quadrangular holes.

6. The image formation apparatus according to claim 4, wherein the supporting section includes a rotatable drum that causes the endless belt to run.
